(19) United States
(12) Patent Application Publication
(10) Pub. No.: US 2009/0204384 A1
(43) Pub. Date: Aug. 13, 2009

(54) DEBUGGING DEVICE, DEBUGGING METHOD AND HARDWARE EMULATOR

(75) Inventors: Takashi AKIBA, Kanagawa-ken (JP); Takashi Miura, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 12/367,761

(22) Filed: Feb. 9, 2009

(30) Foreign Application Priority Data
Feb. 12, 2008 (JP) 2008-030962

(51) Int. Cl. G06F 9/455

(52) U.S. Cl. 703/28

(57) ABSTRACT

A hardware emulator having: a verification target circuit that includes a CPU in which progress of instruction execution is controlled by a program counter, and a circuit that operates according to the instruction execution by the CPU; at least one replica circuit that is formed by replication of the verification target circuit; a debug controller that starts operation of the verification target circuit upon receipt of an operation start signal from an outside of the hardware emulator, and that stops operation of the verification target circuit and the replica circuit when a value of the program counter of the verification target circuit reaches a predetermined breakpoint; an execution start delaying portion that causes the replica circuit to start execution of an instruction with a delay equivalent to a predetermined number of instructions after the verification target circuit starts execution of the same instruction; a program counter controller that performs control so that the value of the program counter of the verification target circuit and a value of a program counter of the replica circuit are simultaneously updated when both of the verification target circuit and the replica circuit complete the execution of their respective running instructions; and an output portion that sends an output from any one of the verification target circuit and the replica circuit to the outside of the hardware emulator in response to a request from the outside of the hardware emulator.

### CROSS-REFERENCE TO RELATED APPLICATIONS

This application is based upon and claims the benefit of priority from the prior Japanese Patent Application No. 2008-30962, filed Feb. 12, 2008, the entire contents of which are incorporated herein by reference.

### BACKGROUND OF THE INVENTION

1. Field of the Invention

The present invention relates to a debugging device, a debugging method and a hardware emulator.

2. Description of the Prior Art

Operation verification for a system large scale integration (LSI) for mounting thereon a CPU is often performed by use of a program that is to run on the CPU. On that occasion, if a proven existing CPU is used, a bug can be encountered in one or both of a newly designed circuit portion and program outside the CPU.

Therefore, debugging at the occurrence of a bug generally involves, first, classifying the bug according to which of the LSI circuit and program the bug is encountered in; then, specifying which instruction of the program is being executed when a problem comes to the surface; and analyzing how the circuit operates during the program's execution, while reproducing and executing the program, starting with one or more instructions prior to the specified instruction.

It takes time to perform simulation to check the LSI circuit operation, when proceeding with such debugging. The harmful effect of such time-consuming simulation is significant in particular with the large-scale integrated (LSI) circuit. For this reason, a hardware emulator in which LSI circuit description data is mapped into a field programmable gate array (FPGA) or the like is used in place of a simulator, to perform cooperative debugging of CPU operation (or software) and hardware, and thereby to achieve a reduction in debug time.

A software debugger and a hardware debugger that run, for example, on a personal computer are used for this cooperative debugging.

At the time of execution of the debugging, a method in which: the software debugger proceeds gradually with the execution of the program while setting breakpoints to detect an instruction running when a problem arises, on source code of the program; then, the hardware emulator is rerun; and the hardware debugger performs detailed waveform observations on output from the hardware emulator, starting with one or more instructions prior to the instruction in which the problem is encountered. The above method or the like is used for determination of a circuit in which the problem is encountered.

This reduces the debug time. Nevertheless, there still remains a problem of requiring time for the rerun of the hardware emulator.

As opposed to this, there has heretofore been a proposal of a debugging system that, when a bug is detected from a circuit to be verified, immediately acquires the state of the circuit that is a state before the bug detection (see US Patent Application Publication 2006/0190860, for example). More specifically, this debugging system is configured: to map a verification target circuit and a replica circuit formed by replication of the verification target circuit, into an FPGA; to supply the replica circuit with a delay input that lags behind an input supplied to the verification target circuit, while simultaneously operating the verification target circuit and the replica circuit; and to stop the execution of the replica circuit when a bug is detected in the verification target circuit, and acquire the internal state of the replica circuit observed at that time.

Meanwhile, in the case of a pipelining CPU, the number of clocks required for instruction execution is not constant due to an occurrence of a stall or the like. Thus, if the debugging system uses such a pipeline CPU, the debugging system has a problem of failing to identify how many instructions the instruction running in the replica circuit is behind the instruction executed in the verification target circuit when the bug is detected in the verification target circuit.

Also, there exists the problem that, in some cases, an instruction that causes a bug may have already been executed in the replica circuit, which in turn renders it difficult to identify the bug.

### SUMMARY OF THE INVENTION

According to an aspect of the present invention, there is provided a debugging device comprising: a hardware emulator; a software debugger that controls the hardware emulator; and a hardware debugger that analyzes an output from the hardware emulator, wherein the hardware emulator includes a verification target circuit portion that includes a CPU in which progress of instruction execution is controlled by a program counter, and a circuit that operates according to the instruction execution by the CPU, and at least one replica circuit portion that is formed by replication of the verification target circuit portion, a debug controller that starts operation of the verification target circuit portion upon receipt of an operation start signal outputted by the software debugger, and that stops operation of the verification target circuit portion and the replica circuit portion when a value of the program counter of the verification target circuit portion reaches a breakpoint set by the software debugger, an execution start delaying portion that causes the replica circuit portion to start execution of an instruction with a delay equivalent to a predetermined number of instructions after the verification target circuit portion starts execution of the same instruction, a program counter controller that performs control so that the value of the program counter of the verification target circuit portion and a value of a program counter of the replica circuit portion are simultaneously updated when both of the verification target circuit portion and the replica circuit portion complete the execution of their respective running instructions, and an output portion that sends an output from any one of the verification target circuit portion and the replica circuit portion to the hardware debugger in response to a request from the hardware debugger.

According to another aspect of the present invention, there is provided a debugging method using a hardware emulator on which a verification target circuit portion and at least one replica circuit portion are mounted, a software debugger that controls the hardware emulator, and a hardware debugger that analyzes an output from the hardware emulator, the verification target circuit portion including a CPU in which progress of instruction execution is controlled by a program counter, and also including a circuit that operates according to the instruction execution by the CPU, the at least one replica circuit portion being formed by replication of the verification target circuit portion, the debugging method comprising: setting, by using the software debugger, the number of instructions that specifies a delay with which the replica circuit portion starts instruction execution after the verification target circuit portion starts instruction execution; setting a breakpoint by using the software debugger; outputting an operation start signal from the software debugger, for the verification target circuit portion to start operating; causing the replica circuit portion to start execution of an instruction with the delay equivalent to the set number of instructions after the verification target circuit portion starts execution of the same instruction; proceeding with instruction execution, while performing control so that a value of the program counter of the verification target circuit portion and a value of a program counter of the replica circuit portion are simultaneously updated when both of the verification target circuit portion and the replica circuit portion complete the execution of their respective running instructions; stopping operation of the verification target circuit portion and the replica circuit portion when the value of the program counter of the verification target circuit portion reaches the breakpoint set by the software debugger; and sending an output request from the hardware debugger to the hardware emulator, to cause the replica circuit portion to send an output to the hardware debugger.

According to another aspect of the present invention, there is provided a hardware emulator comprising: a verification target circuit portion that includes a CPU in which progress of instruction execution is controlled by a program counter, and a circuit that operates according to the instruction execution by the CPU; at least one replica circuit portion that is formed by replication of the verification target circuit portion; a debug controller that starts operation of the verification target circuit portion upon receipt of an operation start signal from an outside of the hardware emulator, and that stops operation of the verification target circuit portion and the replica circuit portion when a value of the program counter of the verification target circuit portion reaches a predetermined breakpoint; an execution start delaying portion that causes the replica circuit portion to start execution of an instruction with a delay equivalent to a predetermined number of instructions after the verification target circuit portion starts execution of the same instruction; a program counter controller that performs control so that the value of the program counter of the verification target circuit portion and a value of a program counter of the replica circuit portion are simultaneously updated when both of the verification target circuit portion and the replica circuit portion complete the execution of their respective running instructions; and an output portion that sends an output from any one of the verification target circuit portion and the replica circuit portion to the outside of the hardware emulator in response to a request from the outside of the hardware emulator.

### BRIEF DESCRIPTION OF THE DRAWINGS

FIG. 1 is a block diagram showing an example of configuration of a debugging device according to a first embodiment of the present invention.

FIG. 2 is a chart showing an example of instruction execution processing performed by a pipelining CPU.

FIG. 3 is a circuit diagram showing an example of configuration of a program counter controller according to the first embodiment.

FIG. 4 is a waveform chart showing an example of operation of a hardware emulator according to the first embodiment.

FIG. 5 is a flowchart showing an example of flow of processing by the debugging method according to a second embodiment of the present invention.

### DESCRIPTION OF THE PREFERRED EMBODIMENTS

Description will be given below with regard to embodiments of the present invention with reference to the drawings.

### First Embodiment

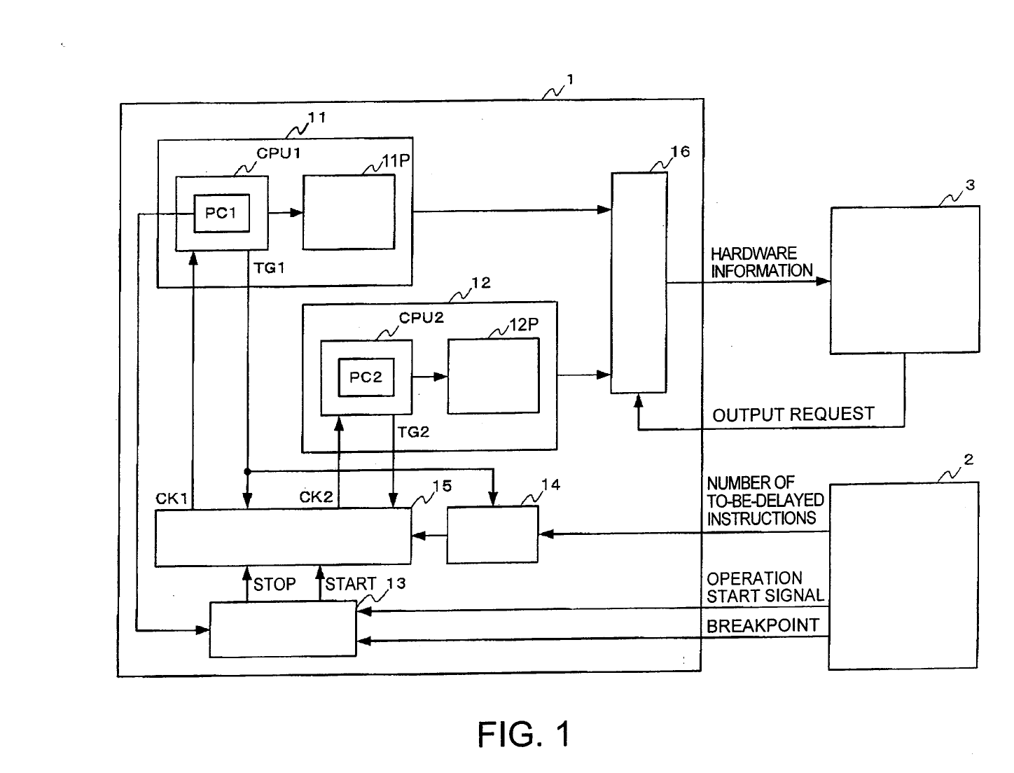

FIG. 1 is a block diagram showing an example of configuration of a debugging device according to a first embodiment of the present invention.

The debugging device according to the first embodiment includes a hardware emulator 1, a software debugger 2 that controls the hardware emulator 1, and a hardware debugger 3 that analyzes output from the hardware emulator 1.

The hardware emulator 1 includes: a verification target circuit portion 11 that includes a CPU1 in which progress of instruction execution is controlled by a program counter PC1, and a peripheral circuit 11P that operates according to the instruction execution by the CPU1; a replica circuit portion 12 that is a circuit formed by replication of the verification target circuit portion 11, that includes a CPU2 in which progress of instruction execution is controlled by a program counter PC2, and that includes a peripheral circuit 12P that operates according to the instruction execution by the CPU2; a debug controller 13 that starts operation of the verification target circuit portion 11 upon receipt of an operation start signal outputted by the software debugger 2 and that stops the operation of the verification target circuit portion 11 and the replica circuit portion 12 when the value of the program counter PC1 of the verification target circuit portion 11 reaches a breakpoint set by the software debugger 2; an execution start delaying portion 14 that causes the replica circuit portion 12 to start execution of an instruction with a delay after the verification target circuit portion 11 starts execution of the same instruction, the delay being equivalent to the number of to-be-delayed instructions set by the software debugger 2; a program counter controller 15 that performs control so that a value of the program counter PC1 of the verification target circuit portion 11 and a value of the program counter PC2 of the replica circuit portion 12 are simultaneously updated when both of the verification target circuit portion 11 and the replica circuit portion 12 complete the execution of their respective running instructions; and an output portion 16 that sends out to the hardware debugger 3 output from any one of the verification target circuit portion 11 and the replica circuit portion 12 in response to an output request from the hardware debugger 3.

The software debugger 2 sets the number of to-be-delayed instructions that specifies how long the start of instruction execution by the replica circuit portion 12 lags behind the start of instruction execution by the verification target circuit portion 11, and a breakpoint for the program counter PC1 of the verification target circuit portion 11, and then outputs an operation start signal, thereby to allow the hardware emulator 1 to start running a program.

The hardware debugger 3 is a tool that sends the output request, receives the output from any one of the verification target circuit portion 11 and the replica circuit portion 12, and, for example, provides waveform display or the like, thereby to perform operation analysis on any one of the verification target circuit portion 11 and the replica circuit portion 12.

Here, the CPU1 and CPU2, as employed in the first embodiment, are each a processor that uses pipelining for instruction execution.

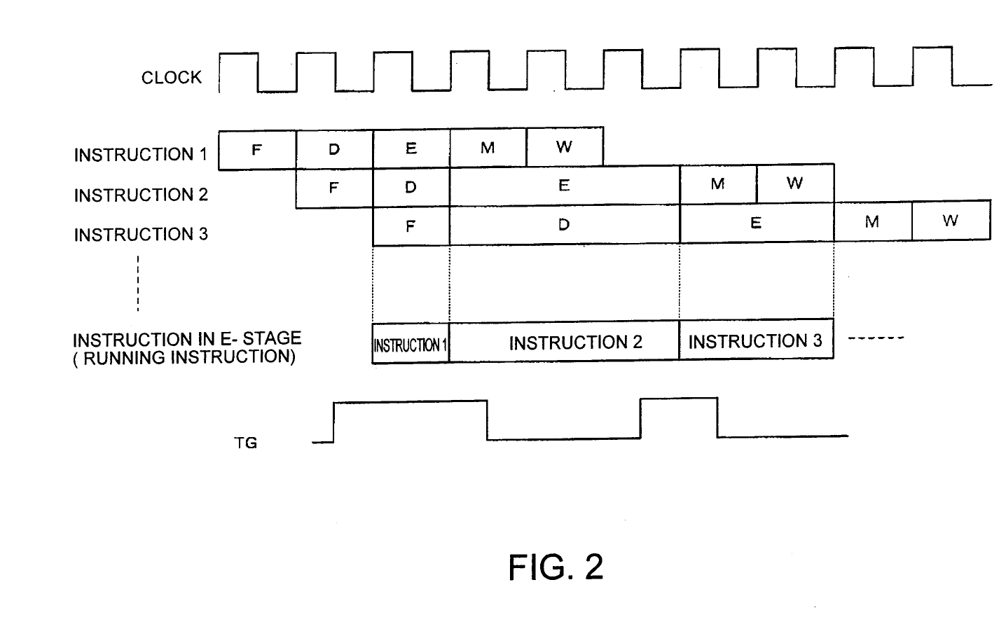

FIG. 2 shows an example of instruction execution processing performed by a pipelining CPU. Here, the pipelining includes five stages: F (instruction fetch), D (decoding), E (execution), M (memory access), and W (register write back).

Pipeline processing involves stopping (or stalling) the pipeline processing when processing at a certain stage is not completed within unit time under an instruction, and waiting for the completion of the processing.

FIG. 2 shows that the CPU sequentially executes an instruction 1, an instruction 2, an instruction 3, . . . , and so on, and more specifically shows the status of processing at each of the stages where the instructions 2 and 3 cause a stall of two cycles and a stall of one cycle, respectively, in the E-stage.

Here, assuming that an instruction being executed at the E-stage is called “running instruction,” processing time of the running instruction is: one cycle for the instruction 1; three cycles for the instruction 2; and two cycles for the instruction 3.

Incidentally, the CPU, as employed in the first embodiment, outputs a program counter change trigger signal TG when changing the running instruction. As shown in FIG. 2, when the program counter change trigger signal TG is outputted as ‘1,’ the E-stage starts processing the next instruction.

As shown in FIG. 2, the pipelining is such that the processing time for the running instruction is not constant but changes depending on the instruction. Therefore, it is not always clear which preceding cycle the immediately preceding instruction has been executed in, even if a bug comes to the surface during the execution of a certain instruction and thus there is a desire for an analysis of the status of execution of the immediately preceding instruction, for example, for debugging.

In the first embodiment, therefore, the replica circuit portion 12 executes an instruction that always lags behind that executed by the verification target circuit portion 11 by a predetermined number of instructions, regardless of whether a processing cycle for the running instruction is short or long, and thus the replica circuit portion 12 always executes the instruction lagging behind by the predetermined number of instructions, when the verification target circuit portion 11 stops its processing.

Thus, in the first embodiment, the program counter controller 15 monitors the output level of a program counter change trigger signal TG1 outputted by the CPU1 of the verification target circuit portion 11 and the output level of a program counter change trigger signal TG2 outputted by the CPU2 of the replica circuit portion 12, and performs control so that the value of the program counter PC1 of the verification target circuit portion 11 and the value of the program counter PC2 of the replica circuit portion 12 are simultaneously updated when both of the verification target circuit portion 11 and the replica circuit portion 12 complete the execution of their respective running instructions

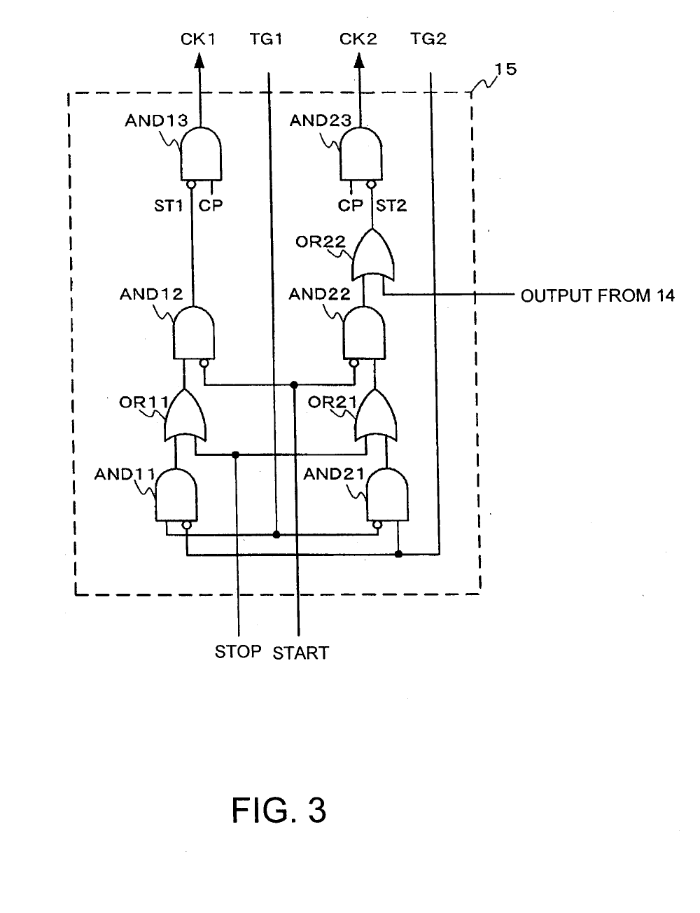

FIG. 3 shows a specific example of a circuit for the program counter controller 15.

Firstly, description will now be given with regard to the signal level of each of signals inputted to the program counter controller 15.

A start signal inputted from the debug controller 13 is such that a ‘1’ pulse is outputted at the time of start of debugging, while, otherwise, the signal is ‘0.’ Also, a stop signal inputted from the debug controller 13 is such that the signal is ‘0’ under normal operating conditions, while the signal becomes ‘1’ when the value of the program counter PC1 of the verification target circuit portion 11 matches the breakpoint value.

A signal outputted by the execution start delaying portion 14 is such that the signal is held ‘1’ during a period of time equivalent to the number of to-be-delayed instructions set by the software debugger 2, and thereafter, the signal is held ‘0.’

The program counter change trigger signals TG1 and TG2 are such that the signals are ‘0’ during the execution of the running instruction at the E-stage in each CPU, while the signals become ‘1’ at the time of changing the running instruction.

In FIG. 3, AND gates AND11 and AND21 monitor the state of changes in the program counter change trigger signals TG1 and TG2.

An output from the AND gate AND11 is inputted via an OR gate OR11 and an AND gate AND12 to an AND gate AND13 that generates a clock CK1 for the CPU1 of the verification target circuit portion 11. Here, assuming that an output from the AND gate AND12 is a clock stop/operation signal ST1, the AND gate AND13 outputs a clock pulse signal CP as the clock CK1 when the clock stop/operation signal ST1 is ‘0,’ while the AND gate AND13 stops the clock CK1 when the clock stop/operation signal ST1 is ‘1.’

Also, an output from the AND gate AND21 is inputted via an OR gate OR21, an AND gate AND22 and an OR gate OR22 to an AND gate AND23 that generates a clock CK2 for the CPU2 of the replica circuit portion 12. Here, assuming that an output from the OR gate OR22 is a clock stop/operation signal ST2, the AND gate AND23 outputs a clock pulse signal CP as the clock CK2 when the clock stop/operation signal ST2 is ‘0,’ while the AND gate AND23 stops the clock CK2 when the clock stop/operation signal ST2 is ‘1.’

In the circuit shown in FIG. 3, when the start signal becomes ‘1’ (that is, at the time of start of debugging), the output from the AND gate AND12, namely, the clock stop/operation signal ST1 becomes ‘0’ so that the AND gate AND13 starts outputting the clock CK1. At the same time, an output from the AND gate AND22 also becomes ‘0,’ but the signal inputted from the execution start delaying portion 14 to the OR gate OR22 holds the clock stop/operation signal ST2 as ‘1’ during the period of time equivalent to the number of to-be-delayed instructions, and thereafter, the signal ST2 becomes ‘0.’ When the clock stop/operation signal ST2 becomes ‘0,’ the AND gate AND23 starts outputting the clock CK2.

After that, during the instruction execution by the CPU1 and the CPU2, the clocks CK1 and CK2 may possibly be stopped depending on the correlation between the program counter change trigger signals TG1 and TG2.

Specifically, when the program counter change trigger signal TG1 is ‘1’ and the program counter change trigger signal TG2 is ‘0,’ the output from the AND gate AND11 becomes ‘1,’ and the clock stop/operation signal ST1 becomes ‘1,’ so that the clock CK1 is stopped.

On the other hand, when the program counter change trigger signal TG1 is ‘0’ and the program counter change trigger signal TG2 is ‘1,’ the output from the AND gate AND21 becomes ‘1,’ and the clock stop/operation signal ST2 becomes ‘1,’ so that the clock CK2 is stopped.

After that, when the value of the program counter PC1 of the verification target circuit portion 11 matches the breakpoint value, the stop signal inputted from the debug controller 13 becomes ‘1,’ outputs from the OR gates OR11 and OR21 become ‘1,’ and the program counter change trigger signals TG1 and TG2 become ‘1,’ so that both the clocks CK1 and CK2 are stopped.

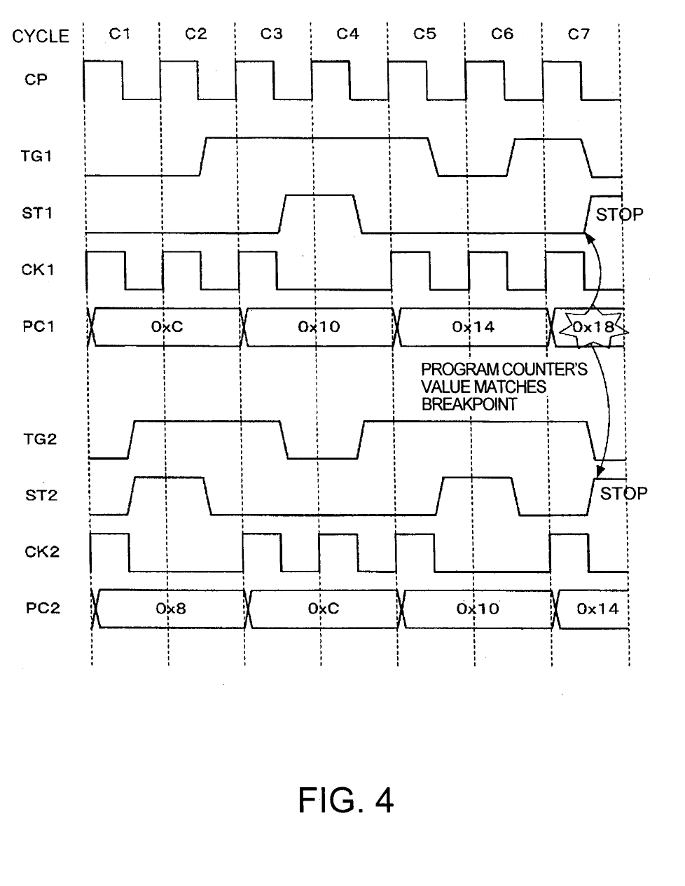

FIG. 4 shows in waveform chart illustrating an example of operation of the hardware emulator 1 of the first embodiment. Here, there is shown an instance where the software debugger 2 sets “1” for the number of to-be-delayed instructions, and sets “0x18” for the breakpoint. Also, it is assumed that the instructions indicated by the values of the program counters are such that, for the execution of the E-stage, one cycle is required for instructions “0x8” and “0x10,” and two cycles are required for instructions “0xC” and “0x14.” Here, the instructions “0x8” and “0x10” are called “one-cycle instructions,” and the instructions “0xC” and “0x14” are called “two-cycle instructions.”

Description will now be given with regard to the operation of the verification target circuit portion 11 and the replica circuit portion 12 in each cycle.

### Cycle C1

The verification target circuit portion 11 is in the first cycle of the two-cycle instruction “0xC,” and thus, the program counter change trigger signal TG1 is not asserted, the clock stop/operation signal ST1 is not asserted, and the clock CK1 is outputted in the next cycle.

The replica circuit portion 12 executes the one-cycle instruction “0x8,” and thus, the program counter change trigger signal TG2 is asserted. At this time, the program counter change trigger signal TG1 is not asserted, and thus, the clock stop/operation signal ST2 is asserted, and the clock CK2 is stopped in the next cycle.

### Cycle C2

The verification target circuit portion 11 is in the second cycle of the two-cycle instruction “0xC,” and thus, the program counter change trigger signal TG1 is asserted. In addition, the program counter change trigger signal TG2 has been also asserted, and thus, the clock stop/operation signal ST1 is not asserted, and the clock CK1 is outputted in the next cycle.

The replica circuit portion 12 holds the state of the previous cycle since the clock CK2 is stopped. The program counter change trigger signal TG1 is asserted, and thus, the clock stop/operation signal ST2 is deasserted, and the clock CK2 is outputted in the next cycle.

### Cycle C3

The verification target circuit portion 11 executes the one-cycle instruction “0x10,” and thus, the program counter change trigger signal TG1 is asserted. At this time, the program counter change trigger signal TG2 is not asserted, and thus, the clock stop/operation signal ST1 is asserted, and the clock CK1 is stopped in the next cycle.

The replica circuit portion 12 is in the first cycle of the two-cycle instruction “0xC,” and thus, the program counter change trigger signal TG2 is not asserted, the clock stop/operation signal ST2 is not asserted, and the clock CK2 is outputted in the next cycle.

### Cycle C4

The verification target circuit portion 11 holds the state of the previous cycle since the clock CK1 is stopped. The program counter change trigger signal TG2 has been asserted, and thus, the clock stop/operation signal ST1 is deasserted, and the clock CK1 is outputted in the next cycle.

The replica circuit portion 12 is in the second cycle of the two-cycle instruction “0xC,” and thus, the program counter change trigger signal TG2 is asserted. In addition, the program counter change trigger signal TG1 is also asserted, and thus, the clock stop/operation signal ST2 is not asserted, and the clock CK2 is outputted in the next cycle.

### Cycle C5

The verification target circuit portion 11 is in the first cycle of the two-cycle instruction “0x14,” and thus, the program counter change trigger signal TG1 is not asserted, the clock stop/operation signal ST1 is not asserted, and the clock CK1 is outputted in the next cycle.

The replica circuit portion 12 executes the one-cycle instruction “0x10,” and thus, the program counter change trigger signal TG2 is asserted. At this time, the program counter change trigger signal TG1 is not asserted, and thus, the clock stop/operation signal ST2 is asserted, and the clock CK2 is stopped in the next cycle.

### Cycle C6

The verification target circuit portion 11 is in the second cycle of the two-cycle instruction “0x14,” and thus, the program counter change trigger signal TG1 is asserted. In addition, the program counter change trigger signal TG2 has also been asserted, and thus, the clock stop/operation signal ST1 is not asserted, and the clock CK1 is outputted in the next cycle.

The replica circuit portion 12 holds the state of the previous cycle since the clock CK2 is stopped. The program counter change trigger signal TG1 is asserted, and thus, the clock stop/operation signal ST2 is deasserted, and the clock CK2 is outputted in the next cycle.

### Cycle C7

The verification target circuit portion 11 asserts the clock stop/operation signal ST1 since the value of the program counter PC1 matches the breakpoint value “0x18.” At the same time, the replica circuit portion 12 also asserts the clock stop/operation signal ST2.

According to the first embodiment, as described above, the verification target circuit portion 11 and the replica circuit portion 12 mutually monitor the status of instruction execution. When one of the circuit portions 11 and 12 ends its own instruction execution while the other one of them is in the process of instruction execution, the one does not proceed with its own instruction execution but waits for the completion of the instruction execution by the other. With this, the interval between instruction executions by the verification target circuit portion 11 and the replica circuit portion 12 is always kept at the value of the number of to-be-delayed instructions set by the software debugger 2. This enables immediate determination of which instruction is being executed by the replica circuit portion 12 when the value of the program counter PC1 of the verification target circuit portion 11 matches the breakpoint value.

The hardware debugger 3 analyzes the internal state of the replica circuit portion 12 that is stopped in response to the breakpoint being reached, thereby determining whether the cause of the encounter of a bug lies in the execution of the instruction corresponding to the number of to-be-delayed instructions set by the software debugger 2.

At that time, if a determination is made that the bug is not encountered in the execution of the instruction corresponding to the number of to-be-delayed instructions, the hardware debugger 3 can send a request for the replica circuit portion 12 to execute operation after the time point where the operation has been stopped, and analyze the internal state of the replica circuit portion 12. Accordingly, it is possible to determine at which point in time the bug is encountered after the stop of the operation.

### Second Embodiment

By referring to a second embodiment, description will be given with regard to a debugging method using the debugging device of the first embodiment.

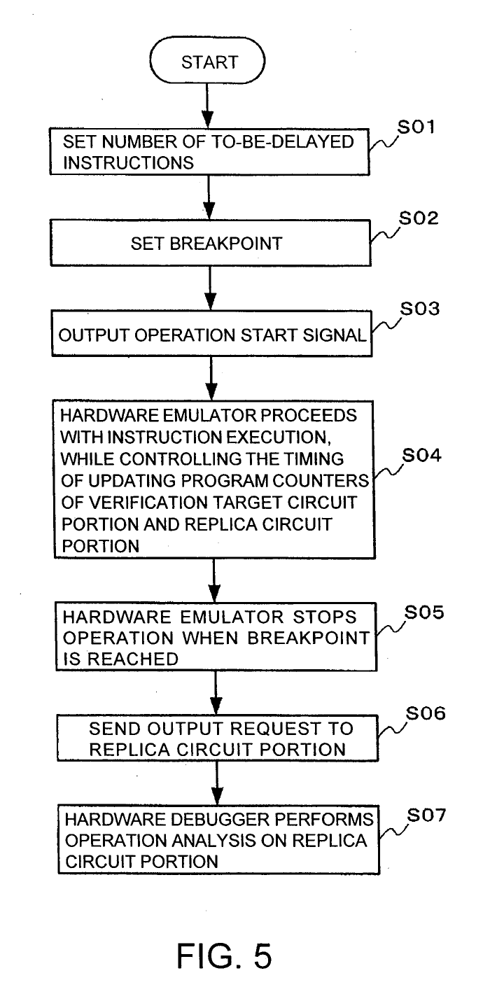

FIG. 5 is a flowchart showing an example of flow of processing by the debugging method of the second embodiment.

At the start of debugging, first, the software debugger 2 sets the number of to-be-delayed instructions for the replica circuit portion 12 (Step S01), and sets a breakpoint (Step S02), and then outputs an operation start signal (Step S03).

Upon receipt of the operation start signal, the hardware emulator 1 starts operating. At that time, in the hardware emulator 1, the verification target circuit portion 11 starts execution of an instruction before the replica circuit portion 12, and the replica circuit portion 12 then starts execution of the same instruction as the verification target circuit portion 11 but with a delay equivalent to the number of to-be-delayed instructions set at Step S01.

After that, the hardware emulator 1 proceeds with the instruction execution, while performing control so that the value of the program counter PC1 of the verification target circuit portion 11 and the value of the program counter PC2 of the replica circuit portion 12 are simultaneously updated when both of the verification target circuit portion 11 and the replica circuit portion 12 complete the execution of their respective running instructions (Step S04).

After that, the hardware emulator 1 stops the operation of the verification target circuit portion 11 and the replica circuit portion 12 when the value of the program counter PC1 of the verification target circuit portion 11 reaches the breakpoint set by the software debugger 2 (Step S05).

Then, the hardware debugger 3 sends an output request to the hardware emulator 1 and causes the hardware emulator 1 to send out the output from the replica circuit portion 12 to the hardware debugger 3 (Step S06).

The hardware debugger 3 then performs operation analysis on the output from the replica circuit portion 12 (Step S07).

The operation analysis by the hardware debugger 3 determines the cause of a bug encountered at the breakpoint during program execution by the verification target circuit portion 11.

At that time, if a determination is made that the bug is not encountered in the execution of the instruction corresponding to the number of to-be-delayed instructions, the hardware debugger 3 can send a request for the replica circuit portion 12 to execute operation after the time point where the operation has been stopped, and analyze the internal state of the replica circuit portion 12. Accordingly, it is possible to determine at which point in time the bug is encountered after the stop of the operation.

Incidentally, the analysis may estimate that the cause of the bug lies in the execution of a further previous instruction. In such a case, the number of to-be-delayed instructions set at Step S01 may be increased and then redo the processing along the flow shown in FIG. 5. In this way, the processing can go back by the increased number of to-be-delayed instructions so that the range of analysis of the cause of the bug is widened.

According to the second embodiment, as described above, setting the number of to-be-delayed instructions allows immediate operation analysis between the instruction in which the bug is encountered and the previous instruction corresponding to the number of to-be-delayed instructions, and thereby efficiently proceeds with debugging operation.

Incidentally, in the above-mentioned embodiments, description has been given taking an instance where the number of replicating portions is one; however, the number of replicating portions may be two or more. In such case, the different numbers of to-be-delayed instructions may be set for the replicating portions, thereby to prepare plural starting points for the analysis at the occurrence of a bug. This allows the operating conditions of the replicating portions at the plural analysis points to be obtained with a single operation, without having to rerun the hardware emulator, when performing debugging while going back instruction execution from the instruction in which the bug is encountered to a previous instruction, thus achieving a further improvement in the efficiency of debugging operation.

What is claimed is:

1. A debugging device comprising:
a hardware emulator;
a software debugger that controls the hardware emulator; and
a hardware debugger that analyzes an output from the hardware emulator, wherein
the hardware emulator includes
a verification target circuit portion that includes a CPU in which progress of instruction execution is controlled by a program counter, and a circuit that operates according to the instruction execution by the CPU, and
at least one replica circuit portion that is formed by replication of the verification target circuit portion,
a debug controller that starts operation of the verification target circuit portion upon receipt of an operation start signal outputted by the software debugger, and that stops operation of the verification target circuit portion and the replica circuit portion when a value of the program counter of the verification target circuit portion reaches a breakpoint set by the software debugger,
an execution start delaying portion that causes the replica circuit portion to start execution of an instruction with a delay equivalent to a predetermined number of instructions after the verification target circuit portion starts execution of the same instruction,
a program counter controller that performs control so that the value of the program counter of the verification target circuit portion and a value of a program counter of the replica circuit portion are simultaneously updated when both of the verification target circuit portion and the replica circuit portion complete the execution of their respective running instructions, and
an output portion that sends an output from any one of the verification target circuit portion and the replica circuit portion to the hardware debugger in response to a request from the hardware debugger.

2. The debugging device according to claim 1, wherein the debug controller directs the replica circuit portion to execute operation starting from a time point where operation is stopped, in response to a request from the hardware debugger.

3. The debugging device according to claim 1, wherein the CPU of the verification target circuit portion and a CPU of the replica circuit portion are each a pipelining CPU having an instruction execution stage.

4. The debugging device according to claim 3, wherein the program counter controller controls the program counter of the verification target circuit portion and the program counter of the replica circuit portion so that a start timing of the instruction execution stage of the CPU of the verification target circuit portion coincides with a start timing of the instruction execution stage of the CPU of the replica circuit portion.

5. The debugging device according to claim 1, comprising a plurality of the replica circuit portions, wherein the predetermined numbers of instructions set for the respective replica circuit portions vary from one another.

6. The debugging device according to claim 1, wherein
the CPU outputs a program counter change trigger signal when changing a running instruction, and
the program counter controller includes a logic circuit that receives the program counter change trigger signal from the verification target circuit portion and the program counter change trigger signal from the replica circuit portion, and that performs logic operation using the program counter change trigger signals.

7. A debugging method using a hardware emulator on which a verification target circuit portion and at least one replica circuit portion are mounted, a software debugger that controls the hardware emulator, and a hardware debugger that analyzes an output from the hardware emulator, the verification target circuit portion including a CPU in which progress of instruction execution is controlled by a program counter, and also including a circuit that operates according to the instruction execution by the CPU, the at least one replica circuit portion being formed by replication of the verification target circuit portion, the debugging method comprising:
setting, by using the software debugger, the number of instructions that specifies a delay with which the replica circuit portion starts instruction execution after the verification target circuit portion starts instruction execution;
setting a breakpoint by using the software debugger;
outputting an operation start signal from the software debugger, for the verification target circuit portion to start operating;
causing the replica circuit portion to start execution of an instruction with the delay equivalent to the set number of instructions after the verification target circuit portion starts execution of the same instruction;
proceeding with instruction execution, while performing control so that a value of the program counter of the verification target circuit portion and a value of a program counter of the replica circuit portion are simultaneously updated when both of the verification target circuit portion and the replica circuit portion complete the execution of their respective running instructions;
stopping operation of the verification target circuit portion and the replica circuit portion when the value of the program counter of the verification target circuit portion reaches the breakpoint set by the software debugger; and
sending an output request from the hardware debugger to the hardware emulator, to cause the replica circuit portion to send an output to the hardware debugger.

8. The debugging method according to claim 7, wherein the hardware debugger directs the replica circuit portion to execute operation starting from a time point where operation is stopped.

9. The debugging method according to claim 7, wherein, if a bug cannot be specified with a single execution, the number of instructions by which the start of instruction execution by the replica circuit portion is delayed is increased, and the hardware emulator is then rerun.

10. The debugging method according to claim 8, wherein, if a bug cannot be specified with a single execution, the number of instructions by which the start of instruction execution by the replica circuit portion is delayed is increased, and the hardware emulator is then rerun.

11. The debugging method according to claim 7, wherein the CPU of the verification target circuit portion and a CPU of the replica circuit portion are each a pipelining CPU having an instruction execution stage.

12. The debugging method according to claim 7, wherein the program counter of the verification target circuit portion and the program counter of the replica circuit portion are controlled so that a start timing of the instruction execution stage of the CPU of the verification target circuit portion coincides with a start timing of the instruction execution stage of the CPU of the replica circuit portion.

13. The debugging method according to claim 7, wherein
a plurality of the replica circuit portions are provided, and
the numbers of instructions set for the respective replica circuit portions by the software debugger vary from one another, each of the numbers of instructions representing a delay with which the start of instruction execution by the corresponding replica circuit portion lags behind the start of instruction execution by the verification target circuit portion.

14. The debugging method according to claim 7, wherein the CPU outputs a program counter change trigger signal when changing a running instruction, and logic operation is performed using the program counter change trigger signal from the verification target circuit portion and the program counter change trigger signal from the replica circuit portion.

15. A hardware emulator comprising:
a verification target circuit portion that includes a CPU in which progress of instruction execution is controlled by a program counter, and a circuit that operates according to the instruction execution by the CPU;
at least one replica circuit portion that is formed by replication of the verification target circuit portion;
a debug controller that starts operation of the verification target circuit portion upon receipt of an operation start signal from an outside of the hardware emulator, and that stops operation of the verification target circuit portion and the replica circuit portion when a value of the program counter of the verification target circuit portion reaches a predetermined breakpoint;
an execution start delaying portion that causes the replica circuit portion to start execution of an instruction with a delay equivalent to a predetermined number of instructions after the verification target circuit portion starts execution of the same instruction;
a program counter controller that performs control so that the value of the program counter of the verification target circuit portion and a value of a program counter of the replica circuit portion are simultaneously updated when both of the verification target circuit portion and the replica circuit portion complete the execution of their respective running instructions; and
an output portion that sends an output from any one of the verification target circuit portion and the replica circuit portion to the outside of the hardware emulator in response to a request from the outside of the hardware emulator.

16. The hardware emulator according to claim 15, wherein the debug controller directs the replica circuit portion to execute operation starting from a time point where operation is stopped, in response to a request from the outside.

17. The hardware emulator according to claim 15, wherein the CPU of the verification target circuit portion and a CPU of the replica circuit portion are each a pipelining CPU having an instruction execution stage.

18. The hardware emulator according to claim 17, wherein the program counter controller controls the program counter of the verification target circuit portion and the program counter of the replica circuit portion so that a start timing of the instruction execution stage of the CPU of the verification target circuit portion coincides with a start timing of the instruction execution stage of the CPU of the replica circuit portion.

19. The hardware emulator according to claim 15, comprising a plurality of the replica circuit portions, wherein the predetermined numbers of instructions set for the replica circuit portions vary from one another.

20. The hardware emulator according to claim 15, wherein
the CPU outputs a program counter change trigger signal when changing a running instruction, and
the program counter controller includes a logic circuit that receives the program counter change trigger signal from the verification target circuit portion and the program counter change trigger signal from the replica circuit portion, and that performs logic operation using the program counter change trigger signals.
